(19) United States
(12) Patent Application Publication
(10) Pub. No.: US 2025/0052297 A1
(43) Pub. Date: Feb. 13, 2025

(54) SUPPORTING STRUCTURE

(71) Applicant: Honda Motor Co., Ltd., Tokyo (JP)

(72) Inventors: Eijiro NISHIMURA, Saitama (JP); Atsushi KOJIMA, Tokyo (JP); Masaaki YAMANE, Tokyo (JP)

(73) Assignee: Honda Motor Co., Ltd., Tokyo (JP)

(21) Appl. No.: 18/760,052

(22) Filed: Jul. 1, 2024

(30) Foreign Application Priority Data
Aug. 7, 2023 (CN) 202310982709.5

(51) Int. Cl. F16F 15/08

(52) U.S. Cl. CPC F16F 15/08

(57) ABSTRACT

A supporting structure that may reduce the vibration of the compressor input to the vehicle body is provided in the disclosure. The supporting structure is used to support a compressor that compresses gas, and includes elastic members. The elastic members include a first elastic member and a second elastic member. A center of gravity of the compressor is set between the first elastic member and the second elastic member, and the first elastic member is disposed below the center of gravity in an up-and-down direction. The second elastic member is farther away from a compression mechanism side of the compressor than the first elastic member.

### CROSS-REFERENCE TO RELATED APPLICATION

This application claims the priority benefit of China application serial no. 202310982709.5 filed on Aug. 7, 2023. The entirety of the above-mentioned patent application is hereby incorporated by reference herein and made a part of this specification.

### BACKGROUND

### Technical Field

The disclosure relates to a supporting structure.

### Description of Related Art

In order to allow vulnerable groups such as the elderly, the disabled, and children to utilize sustainable transportation systems, we are committed to providing transportation tools with superior vehicular comfort. Among existing technologies, the development of electric vehicles has prompted the trend of using electric compressors. Since the compressor and engine in traditional vehicles are integrated into one structure, there is no need for a separate supporting structure. However, the issue of supporting an electric compressor in the absence of an engine in electric vehicles is a challenge. The disclosure aims to address the aforementioned issue for reducing vibration and noise, thereby further enhancing the comfort of vehicles and contributing to the development of a sustainable transportation system.

### SUMMARY

A supporting structure that may reduce the vibration of the compressor input to the vehicle body is provided in the disclosure.

The supporting structure of the disclosure is used to support a compressor that compresses gas, and includes elastic members. The elastic members include a first elastic member and a second elastic member. A center of gravity of the compressor is set between the first elastic member and the second elastic member, and the first elastic member is disposed below the center of gravity in an up-down direction. The second elastic member is farther away from a compression mechanism side of the compressor than the first elastic member.

Based on the above, in the supporting structure of the disclosure, the first elastic member is disposed below the center of gravity of the compressor, and the second elastic member is disposed away from the compression mechanism side. In this way, the first elastic member is located on the side of the center of gravity with less vibration, which may effectively reduce the vibration input to the vehicle body. It is also formed like a fulcrum, so that the second elastic member uses the lever principle to suppress the vibration (larger vibration) on the other end of the compression mechanism side. Accordingly, the supporting structure of the disclosure may reduce the vibration input from the compressor to the vehicle body.

In order to make the above-mentioned features and advantages of the disclosure comprehensible, embodiments accompanied with drawings are described in detail below.

### BRIEF DESCRIPTION OF THE DRAWINGS

FIG. 1 is a front schematic diagram of a supporting structure applied to a compressor of an embodiment of the disclosure.

FIG. 2 is a side schematic diagram of the supporting structure of FIG. 1 applied to a compressor.

FIG. 3 is a three-dimensional schematic diagram of the supporting structure supporting the compressor of this embodiment in the vehicle body.

### DETAILED DESCRIPTION OF DISCLOSED EMBODIMENTS

In an embodiment of the disclosure, an elastic coefficient of the second elastic member is less than an elastic coefficient of the first elastic member.

In an embodiment of the disclosure, from a viewing angle in a first direction, the elastic members are disposed on opposite two sides of the compressor. The elastic members located on the two sides are respectively connected to the center of gravity to form respective lines, and an included angle is formed between the lines. The included angle is set such that a vibration direction of the compressor is a shearing direction of the elastic members.

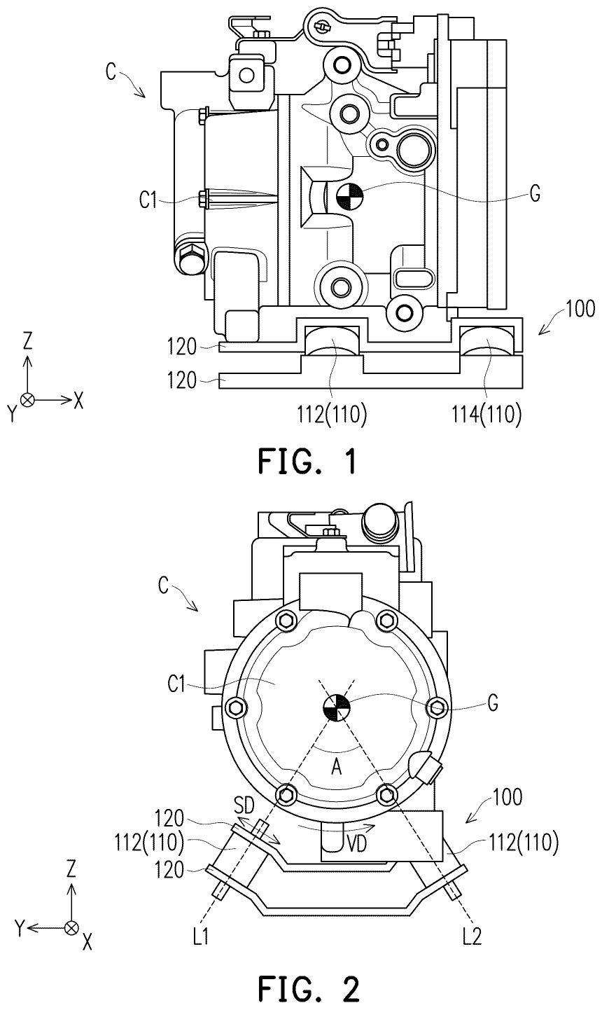

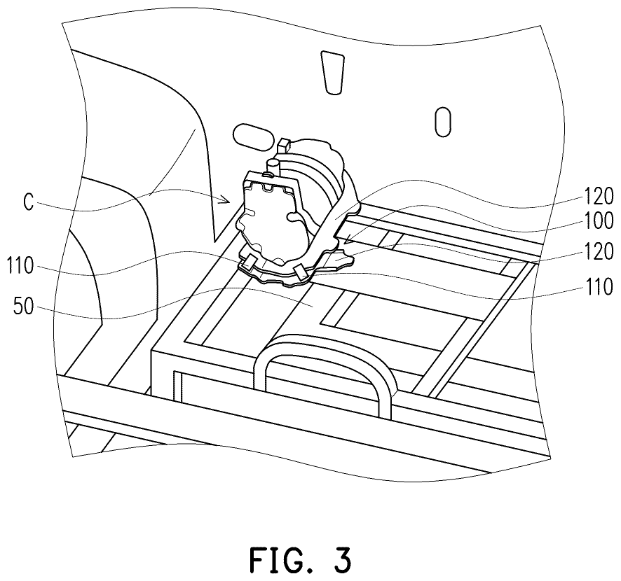

FIG. 1 is a front schematic diagram of a supporting structure applied to a compressor of an embodiment of the disclosure. FIG. 2 is a side schematic diagram of the supporting structure of FIG. 1 applied to a compressor. FIG. 3 is a three-dimensional schematic diagram of the supporting structure supporting the compressor of this embodiment in the vehicle body. In this embodiment, the supporting structure 100 is a structure applied in a vehicle (not shown) to support a compressor C that compresses gas. The compressor C is, for example, a scroll electric compressor, but the disclosure is not limited thereto. The first direction X, the second direction Y, the up-down direction Z, etc. in the drawings are not used to limit the positional relationship of each component in the disclosure. If applicable, the same reference numerals in the drawings and the descriptions indicate the same or similar parts. The supporting structure 100 of this embodiment is described below with reference to FIG. 1 to FIG. 3.

Referring to FIG. 1 to FIG. 3, in this embodiment, the supporting structure 100 includes elastic members 110 and brackets 120. The elastic members 110 are disposed below the compressor C in the up-down direction Z, and are connected to the compressor C and the vehicle body 50 (as shown FIG. 3) through the brackets 120. More specifically, the compressor C is installed in the center and slightly rear side of the motor room of the vehicle body 50 through the brackets 120. An outdoor heat exchanger (not shown) is disposed in front of the compressor C, and an indoor air conditioning system (not shown) is disposed behind the compressor C, but the disclosure is not limited thereto. The vibration direction VD of the compressor C (as shown in FIG. 2) is, for example, vibrating in the counterclockwise direction (not limited thereto), the vibration is smallest at the center of gravity G, and the vibration on two sides relative to the center of gravity G in the first direction is larger, especially the vibration on the compression mechanism side C1 (located to the left of the first direction X in FIG. 1) is the largest.

Furthermore, the elastic member 110 includes a first elastic member 112 and a second elastic member 114 arranged in parallel in the first direction X. The first elastic member 112 is disposed below the center of gravity G in the up-down direction Z and slightly offset toward the compression mechanism side C1. The second elastic member 114 is farther away from the compression mechanism side C1 of the compressor C than the first elastic member 112. That is, the second elastic member 114 is disposed to the right of the first elastic member 112 in the first direction X, and the center of gravity G of the compressor C is disposed between the first elastic member 112 and the second elastic member 114. The elastic member 110 is, for example, rubber for installation, but may also be other suitable elastic materials for buffering, and the disclosure is not limited to rubber.

It may be seen from this that in the supporting structure 100 of this embodiment, the first elastic member 112 is disposed below the center of gravity G of the compressor C, and the second elastic member 114 is disposed away from the compression mechanism side C1. In this way, the first elastic member 112 is located on the side of the center of gravity G with less vibration, which may effectively reduce the vibration input to the vehicle body. It is also formed like a fulcrum, so that the second elastic member 114 uses the lever principle to suppress the vibration (larger vibration) on the other end of the compression mechanism side C1. Accordingly, the supporting structure 100 of this embodiment may reduce the vibration input from the compressor C to the vehicle body.

Preferably, in this embodiment, the elastic coefficient of the second elastic member 114 is less than the elastic coefficient of the first elastic member 112. By setting a smaller elastic coefficient, the vibration on the end side may be more effectively absorbed, thereby suppressing the vibration input to the vehicle body side.

Referring to FIG. 2, in this embodiment, under the viewing angle in the first direction X (i.e., the viewing angle in FIG. 2), the elastic members 110 are disposed on opposite two sides of the compressor C in the second direction Y. Specifically, two first elastic members 112 and two second elastic members 114 are respectively disposed in the second direction Y. However, under the viewing angle in the first direction X (i.e., the viewing angle in FIG. 2), only the first elastic members 112 may be seen. Furthermore, the elastic members 110 located on two sides in the second direction Y are respectively connected to the center of gravity G to form lines L1 and L2, and an included angle A is formed between the lines L1 and L2. The included angle A is set such that the vibration direction VD of the compressor C is the shearing direction SD of the elastic member 110. The configuration in this embodiment results in an included angle A that is less than that in prior arts, and the vibration from the compressor C is input to the elastic member 110 in the shear direction SD, further reducing the vibration input to the vehicle body side.

To sum up, in the supporting structure of the disclosure, the first elastic member is disposed below the center of gravity of the compressor, and the second elastic member is disposed away from the compression mechanism side. In this way, the first elastic member is located on the side of the center of gravity with less vibration, which may effectively reduce the vibration input to the vehicle body. It is also formed like a fulcrum, so that the second elastic member uses the lever principle to suppress the vibration (larger vibration) on the other end of the compression mechanism side. Furthermore, the elastic members are arranged on opposite two sides of the compressor, and the included angle between the elastic members and the center of gravity is set such that the vibration direction of the compressor is the shearing direction of the elastic members. Therefore, the vibration input in the compression direction of the elastic members may be further reduced. Accordingly, the supporting structure of the disclosure may reduce the vibration input from the compressor to the vehicle body.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. A supporting structure, used to support a compressor that compresses gas, comprising elastic members, wherein
the elastic members comprise a first elastic member and a second elastic member, a center of gravity of the compressor is set between the first elastic member and the second elastic member, and
the first elastic member is disposed below the center of gravity in an up-down direction,
the second elastic member is farther away from a compression mechanism side of the compressor than the first elastic member.

2. The supporting structure according to claim 1, wherein,
an elastic coefficient of the second elastic member is less than an elastic coefficient of the first elastic member.

3. The supporting structure according to claim 1, wherein,
from a viewing angle in a first direction, the elastic members are disposed on opposite two sides of the compressor, the elastic members located on the two sides are respectively connected to the center of gravity to form respective lines, and an included angle is formed between the lines, the included angle is set such that a vibration direction of the compressor is a shearing direction of the elastic members.

4. The supporting structure according to claim 2, wherein,
from a viewing angle in a first direction, the elastic members are disposed on opposite two sides of the compressor, the elastic members located on the two sides are respectively connected to the center of gravity to form respective lines, and an included angle is formed between the lines, the included angle is set such that a vibration direction of the compressor is a shearing direction of the elastic members.
